(19) United States
(12) Patent Application Publication
(10) Pub. No.: US 2017/0144500 A1
(43) Pub. Date: May 25, 2017

(54) Automotive Leaf Spring

(71) Applicants: Anatoliy Alekseevich Kuznetsov, Moscow (RU); Arkadiy Moiseevich Peker, Odintsovo Moskovskaya (RU); Igor Semyonovich Lerner, Woodsburgh, NY (US); Semyon Brayman, West Bloomfield, MI (US)

(72) Inventors: Anatoliy Alekseevich Kuznetsov, Moscow (RU); Arkadiy Moiseevich Peker, Odintsovo Moskovskaya (RU); Igor Semyonovich Lerner, Woodsburgh, NY (US); Semyon Brayman, West Bloomfield, MI (US)

(21) Appl. No.: 15/343,554

(22) Filed: Nov. 4, 2016

Related U.S. Application Data
(60) Provisional application No. 62/253,749, filed on Nov. 11, 2015.

(51) Int. Cl. B60G 11/02; F16F 1/18

(52) U.S. Cl. CPC B60G 11/02; F16F 1/185; B60G 2206/72; B60G 2206/428; F16F 2238/022; B60G 2202/11; F16F 2224/0208; F16F 2226/02; B60G 2206/84

(57) ABSTRACT

Automotive leaf springs are produced from low-hardenability and specified hardenability steel, with identical and different length, width and thickness and constant or variable cross section profile, that are subjected to through-surface hardening and low tempering. The ideal critical diameter of hardening, carbon content and hardened layer depth depend on the thickness of constant cross section profile leaf and maximum and minimum thicknesses of variable cross section profile leafs. Adherence to the optimum correlations of parameters indicated make it possible to produce leaf springs with the highest mechanical properties and longevity.

### BACKGROUND OF THE INVENTION

The invention relates to mechanical engineering, particularly to automotive leaf springs.

An automotive leaf spring is known (See patent RU #2213280) that consists of several spring leafs of identical width and different length with a constant or variable profile, are produced from low hardenability (LH) steel subjected to through-surface hardening (TSH). As a result of thermal treatment, each spring leaf had a non-homogenous cross section microstructure: a 52-60 HRC hardness martensite in the surface layer and a 25-47 HRC hardness troostite-sorbite structure in the core.

A positive technical outcome was achieved because this leaf spring showed better bench and field test results compared to commercially produced leaf springs. The latter consist of leafs that are made from alloyed spring steels and subjected to traditional thermal treatment—oil quenching with medium tempering at 400-550° C. to produce a homogenous martensite-microstructure cross section with 40-50 HRC hardness, followed by shot blasting of the surface.

The performance requirements for leaf springs manufactured in Germany, USA and other western countries are much more stringent as compared to the Russian Federation. In order to meet these performance requirements leaf springs are manufactured to higher and tighter hardness ranges. For example, in a number of cases the hardness range is 46-50 HRC or 48-52 HRC, and the leaf bench load is 800±600 N/mm², while in the Russian Federation it is 500±300 N/mm² (See patent RU #2213280). Testing of 11-13 mm thick LH steel leaf plates subjected to TS Hand low tempering (per patent RU #2213280) showed that, at higher loads, in some cases the leafs did not pass the verification criterion of 150,000 cycles.

In addition, occasional failures of individual LH steel leafs and entire leaf spring assemblies subjected to TSH and low tempering occurred as a result of bulldozing of assembled leaf springs in the through central hole or the central indentation in the blind hole. Failures were caused by bigger brittleness of this area due to high hardness of the continuously martensite structure surface (56-62 HRC).

The purpose of this invention is to develop a new automotive leaf spring that consists of low hardenability (LH) or specified hardenability (SH) steel leafs that were subjected to TSH and have even higher reliability and durability.

### SUMMARY OF THE INVENTION

The technical result of the invention is achieved by its following distinctive features:
use of third generation LH and SH steels to produce 8-50 mm thick spring leafs, with the steel chemical composition conforming to Russian Federation patents #2450060, bul. #13, dated Oct. 5, 2012, and #2450079, bul. #13, dated Oct. 5, 2012 Duplicate, wherein the carbon content is 0.4-0.8%; whereas for thicknesses under 8 mm the carbon content is 0.2-0.40%; therewith, the ideal critical hardening diameter DI_{cr}. Of LH and SH steels should conform to the spring leaf thickness in order to facilitate formation of an optimum harden layer depth during TSH; ##1 and 2, that show optimum DI_{cr}. Values of LH and SH steels for various spring leaf thicknesses);
elimination of the ferrite-structured, completely decarburized zone from the harden surface layer that has a purely martensite structure; with partial surface decarburization (not less than 0.15%), presence of a low-carbon martensite structure does not cause abrupt fatigue strength reduction, compared to commercially produced spring leafs with troostite micro structure, followed by shot blasting of the surface;
use of LH steels with 0.2-0.4% carbon and DI_{cr.}=6-10 mm and more to produce spring leafs with thickness under 8 mm. This provides for hardening of the entire spring leaf or its sections with thickness under 8 mm to form a low-carbon martensite structure throughout the cross section, or 45-58 HRC martensite in the surface layer and troosto-martensite in the core. Higher carbon content in the LH steel (0.4-0.8%) that corresponds to the prototype (patent RU #2213280) results in lower fatigue strength and durability with through hardening; conversely, through hardening of thin cross sections of steel parts with 0.2-0.4% carbon to form a homogenous low-carbon martensite structure with ##1-4 acicularity (GOST 8233-56) provides for higher cyclic durability and attainment of results commensurable with spring leafs produced commercially with shot peening; this is explained by smaller tensile residual stresses in surface layers, reasonably high overall strength (σ=1800-2400 N/mm²) and ductility (Ψ=30-50%);
use of cold-work hardening by shot blasting, roller burnishing, ultrasound and any other method of mechanical impact on loaded martensite-structure, high hardness (52-60 HRC) surfaces of LH (SH) steel spring leafs (commercial production technology uses shot peening of leafs made from traditional spring steel with a 40-50 HRC through troostite structure); in the process, there is a qualitative improvement in the microstructure of the most highly stressed surface martensitic layer; the latter transforms into textured martensite with deformed oval-shaped borders of “former” austenite grains; this results in a higher fatigue strength and cyclic durability in the transitional area of limited endurance that considerably exceed the indices for LH steel leaf springs after TSH, with a martensite structure without shot peening (patent RU #2213280), and leaf springs hardened by the traditional method with shot peening of leafs with a troostite structure.

Elimination of another defect mentioned above, i.e. occasional failure of the entire leaf spring or its part along the central zone (the hole or its vicinity) during static bulldozing of assembled leaf springs or overloading during operation is also a technical solution achieved by this invention. These breakages result from accumulation of local stress concentrators in the hole zone and presence of a brittle martensite structure on the hole I.D. or tapered central indentation. Limiting the continuous martensitic hardening zone and preventing it from spreading to the hole zone and its adjoining area is an effective means to reduce brittleness and avoid breakages during static and fatigue loading.

For example, special plugs were used to prevent the quenching fluid from entering the Ø13 mm central hole itself and the adjoining Ø30 mm flat area from both sides. The microstructure of these surfaces was a troosto-sorbite mixture with martensite inclusions, i.e. partial martensite structure penetration in the hole area had occurred. But these local hardened sections that were formed due to gaps between the protective plugs and spring leaf surfaces did not affect the subsequent test results because the local microplastic deformation during spring leaf bulldozing occurred in areas adjacent to plastic non-martensite structures that resulted in relaxation of local stresses caused by external forces. During the trial binding of all the spring leafs together with the help a bolt placed in the central hole or special binding fasteners, the external load in this zone is sharply reduced and presents no danger of destruction in future.

Static and cyclic test results of a prototype batch of springs with leafs made from LH steel subjected to TSH, with areas of restricted hardening in the vicinity of the leaf spring central hole, turned out to be positive: not a single leaf spring being tested broke under static load and at fatigue loading until the nominal number of cycles was completed, and not a single leaf broke in the central hole when the permissible loads were exceeded.

Non-availability of main characteristics of the steel used, namely, LH (SH) steel ideal critical hardening diameter and carbon content depending on the spring leaf thickness constitutes the main shortcoming of the known published materials.

This invention contain specific limiting values of the LH and SH steel ideal critical diameter (DI_{cr.}) and carbon content depending on the thickness of constant and variable profile spring leafs. Non-availability of these main characteristics is the shortcoming of the known published materials.

For example, based on thermophysical calculations for leafs with a constant cross section profile and thickness H (mm), DI_{cr}, min. is 0.6 H, mm, but not less than 6.0 mm, while DI_{cr} max is 1.2 H, mm, i.e. DI_{cr}. Is (0.6-1.2) H, mm, which ensures the δ=(0.1-0.22) H harden layer depth. Table 1 shows permissible DI_{cr}. Values of the harden layer depth δ with respect to the constant-profile leaf thickness H. The carbon content in steel is 0.4-0.8%.

TABLE 1

| | H, mm | | | | | | | | | | | | | |
|---|---|---|---|---|---|---|---|---|---|---|---|---|---|---|
| | 8 | 9 | 10 | 12 | 14 | 16 | 18 | 20 | 22 | 24 | 30 | 40 | 45 | 50 |
| DI_{cr}, | 6-10 | 6-11 | 6-12 | 7-14 | 8-16 | 10-19 | 11-21 | 12-24 | 13-26 | 14-28 | 18-36 | 24-48 | 27-54 | 30-60 |
| mm | | | | | | | | | | | | | | |
| δ, mm | 0.8-1.7 | 0.9-2.0 | 1.0-2.2 | 1.2-2.6 | 1.4-3.1 | 1.6-3.5 | 1.8-4.0 | 2.0-4.4 | 2.2-4.8 | 2.4-5.3 | 3.0-6.6 | 4.0-8.8 | 4.5-10.0 | 5.0-11.0 |

The ideal critical hardening diameter for constant cross section profile leafs whose thickness H is less than 8 mm is: DI_{cr.}>6 MM, C=0.2-0.4%.

Various optimal designs have been developed for variable cross section profile leafs that are eligible for TSH.

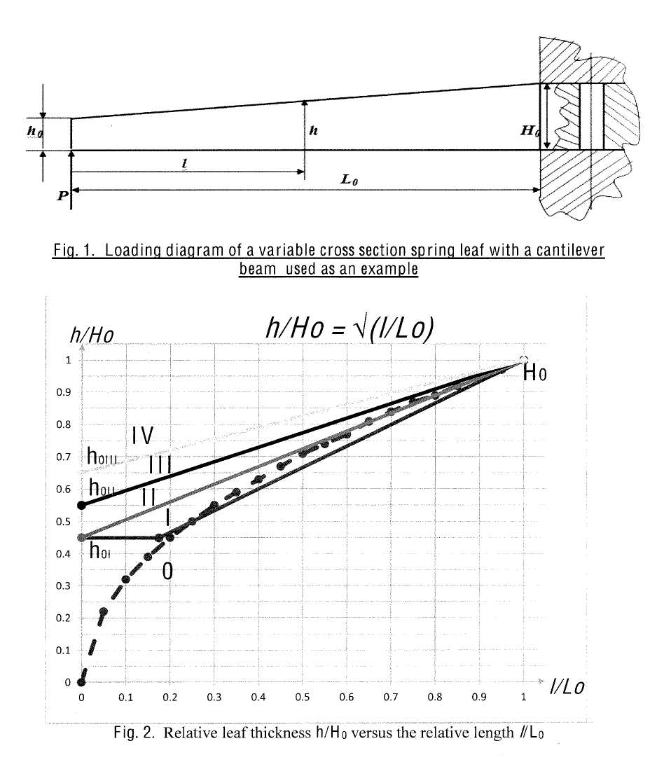

FIG. 1 shows the loading diagram of a spring leaf half with a fixed central section.

In this case, the maximum bending stress is σ_{bend.}=6Pl/bh²=const, where:

P is the support reaction (const);

/ is the length of the arm of force P;

h is a variable value equal to the leaf thickness over length l;

L₀ is the distance from the leaf end (end reaction point) to the fixed-end (const);

b is the leaf width (const); H₀, h₀ are the biggest and smallest leaf thicknesses (const).

By substituting L₀ for l and H₀ for h in the formula, we get:

σ_{bend.}=6PL₀/bH₀²=const;

By equating two expressions, we get h/H₀=√(l/L₀)

FIG. 2 contains a graph that shows relative leaf thickness h/H₀ versus the relative length l/L₀. The graph is a theoretical contour of a constant cross section leaf—the dot-and-dash curve.

There are five zones here, three of which are confined to straight lines:
0—zone with overloaded thin end leaf sections compared with thicker, underloaded mid-sections;
I—minimum TSH application zone—h₀H₀=0.45 min;
II—most optimal TSH application zone—h₀/H₀=0.45-0.55;
III—TSH-acceptable zone which, however, is a high structural rigidity zone—h₀/H₀=0.55-0.65;
IV—irrational configuration zone, where the leaf mass, rigidity and load non-uniformity during bending along it length grow sharply; it is low at the end zones and maximum in the central zone.

With h₀/H₀>0.65, the TSH method may practically be applicable, and, as it approaches h₀/H₀=1, the spring leaf will have a constant profile.

Thus, in case of variable profile leafs, minimum thickness h₀ is the limiting parameter for thermophysical calculations.

With DI_{cr}, min.=0.95 h₀ (mm), DI_{cr}, max=1.2 h₀, the harden layer depth is:

For zones I [symbol] II: h₀=(0.45-0.55) H₀, δ=(0.15-0.22) h₀ or δ=(0.07-0.12) H₀, DI_{cr},=(0.95-1.2) h₀=(0.4-0.65) H₀

For zones III: h₀=(0.55-0.65) H₀, δ=(0.15-0.22) h₀ or δ=(0.08-0.145) H₀, DI_{cr},=(0.95-1.2) h₀=(0.5-0.75) H₀

Table 2 shows permissible ideal critical hardening diameters DI_{cr}, of steel with 0.4-0.8% C depending on the thickness variation—from minimum h₀(mm) to maximum H₀ (mm) with the most optimal variable cross section profile ratio h₀/H₀=0.5.

TABLE 2

| | h0/H0 = 0.5 | | | | | | | | | |
|---|---|---|---|---|---|---|---|---|---|---|
| | 8/16 | 9/18 | 10/20 | 11/22 | 12/24 | 14/28 | 16/32 | 18/36 | 20/40 | 25/50 |
| DI_{cr}, mm | 7-10 | 8-11 | 9-12 | 10-14 | 11-15 | 13-17 | 15-20 | 17-22 | 18-24 | 23-30 |
| δ, mm | 1.2-1.8 | 1.3-2.0 | 1.5-2.2 | 1.6-2.4 | 1.8-2.6 | 2.1-3.1 | 2.4-3.5 | 2.7-3.9 | 3.0-4.4 | 3.7-5.5 |

Therefore, the TSH method is applicable for hardening of spring leafs thicker than 8 mm.

For variable profile leafs, with the minimum thickness of less than 8 mm and maximum more than 8 mm, i.e. h₀<8 mm, H₀=(8-16) mm, DI_{cr},=(6-10) mm, C=0.2-0.4%.

An important distinctive feature of this invention is the specific dependence of two main LH (SH) steel parameters, i.e. its carbon content (% C) and ideal critical diameter DI_{cr}., on the leaf thickness H(h₀). In this case, the permissible nominal carbon content of a specific steel with narrow tolerances (±0.05% or ±0.025%) is selected from broad limits (0.2-0.8% C). For constant and variable cross section profile leafs, permissible ideal critical diameter DI_{cr}, values are also selected from broad limits—(6-60 mm) and 7-30 mm), respectively. Within the framework of Russian Federation patents #2450060, bul. #13, Oct. 5, 2012; and #2450079, bul. #13, Oct. 5, 2012, with the same DI_{cr}, steel chemical elements other than carbon have no impact.

A qualitatively low solution with regard to thermal strengthening of constant and variable cross section spring leafs is a combination of TSH and thermochemical treatment (TCT)—carburization (C) or high temperature carbonitriding (CN), that makes it possible to:—practically completely eliminate spring leaf surface decarburization to the matrix that had occurred during rolling; carbon content in steel is 0.2-0.4%; in this case, the maximum carbon content in the martensite-structure surface layer should not exceed 0.8%, while the minimum carbon content should be more than 0.2% higher than that in the matrix that has a martensite, troosto-martensite, troostite structure (depending on the leaf thickness);
reduce the minimum thicknesses of constant profile spring leafs subjected to thermal treatment from 8 mm (TSH) to 5 mm (TCT), and that of variable profile leafs from 8/16 mm (TSH) to 5/10 mm—(TSH+TCT);
improve the leaf spring durability by additionally creating beneficial residual compressive stresses in the leaf surface layer that were formed as a result of TCT;
work harden the spring leaf surface from its stressed side, during operation, that was effected by shot peening or another mechanical method resulting in higher fatigue endurance similarly to what was described above.

We claim:

1. An automotive leaf spring that consists of one or several leafs produced from low hardenability (LH) and specified (SH) steel, having identical or different lengths, widths and thicknesses, with constant or variable cross section profile, that were subjected to through-surface hardening (TSH) and low tempering, with a distinction that the leafs are made from low hardenability (LH) and specified hardenability (SH) steel with 0.2-0.8% carbon content, as follows:
for constant profile leafs: the ideal critical hardening diameter (C_{cr}., mm) has the following values, depending on the leaf thickness (H, mm): D_{cr}=(0.6-1.2) H, mm, which ensures the harden layer depth (mm) equal to δ=(0.1-0.22) H;
for variable profile leafs: depending on the leaf thickness variation from minimum (h₀, mm—at the end support points) to maximum (H₀, mm—in the leaf center), the range of permissible leaf cross section profiles (h₀/H₀) should not be outside the limits constrained by zones I, II, III on the graph that shows relative thickness h/H₀ versus its relative length//L₀ (see graph); herewith:
for zones I-II, where h₀/H₀=0.45-0.55, the LH (SH) steel ideal critical hardening diameter D_{cr}.=(0.95-1.2) h₀=(0.45-0.65) H₀, which ensures the harden layer depth along the leaf length l from δ=(0.15-0.22) h₀ at the minimum leaf end thickness to δ=(0.07-0.125) H₀ at the maximum leaf thickness in its mid-section;
for zone III, where h₀/H₀=0.55-0.65, the LH (SH) steel ideal critical hardening diameter D_{cr}.=(0.95-1.2) h₀=(0.55-0.75) H₀, which ensure the harden layer depth along the leaf length l from δ=(0.15-0.22) h₀ at the nominal leaf end thickness to δ=(0.1-0.145) H₀ at the maximum leaf thickness in its mid-section.

2. An automotive leaf spring according to claim 1, in which working surfaces of each constant cross section profile leaf with thicknesses bigger than 8 mm and variable profile leaf with a thickness of 0.45-0.65 of the maximum central thickness, but not less than 8 mm, are made from LH (SH) steel with 0.4-0.8% carbon content and have a martensite structure with ##1-5 acicularity, 50 . . . 62 HRC hardness and depth equal to 0.07-0.22 of the leaf thickness, the core structure being troostite, troosto-sorbite-sorbite with 30-50 HRC hardness and #10-14 actual austenite grain.

3. An automotive leaf spring according to claim 1, the working surfaces of each constant cross section profile leaf with thicknesses bigger than 8 MM and variable profile leaf with 0.45-0.65 of the maximum central thickness, but not less than 8 mm, are made from LH (SH) steel with 0.4-0.8% carbon content and have a hardened textured martensite structure with ##1-5 a cicularity, 50 . . . 62 HRC hardness and depth equal to less than 0.22 of the leaf thickness, plastically deformed surface, the core structure being troostite, troosto-sorbite-sorbite with 30-50 HRC hardness and #10-14 actual austenite grain.

4. An automotive leaf spring according to claim 1, spring leaf thin end sections with variable cross section profile (thickness less than 8 mm) and constant profile (less than 8 mm) may be produced with through hardening to form a tempered martensite or tempered martensite in the surface layer with 45-60 HRC hardness, the core structure being troosto-martensite with ##1-5 acicularity and #10-14 actual austenite grain, with 0.2-0.4% carbon content in the LH steel.

5. An automotive leaf spring according to claim 1, spring leaf thin end sections with the variable cross section profile (thickness less than 8 mm) and constant profile (less than 8 mm) may be produced with through hardening to form tempered martensite in the surface layer, the core structure being troosto-martensite, with the surface layer of not more than 0.22 of the leaf thickness, martensite is a cold-worked texture of the plastically deformed surface per claim 3.

6. An automotive leaf spring according to claim 1, that in the vicinity of the spring leaf central hole or centering indentation surface there is a zone with martensite, troosto-martensite, troostite, troosto-sorbite, hardening soorbite structure or with additional Ø<50 mm local tempering from 2 sides, including the hole surface, with 30-56 HRC hardness.

7. An automotive leaf spring according to claim 1, that the spring leaf working surfaces exposed to tensile stresses caused by external forces during operation are subjected to pre-machining that results in formation of a not fully decarburized, <0.1 mm deep, layer.

8. An automotive leaf spring according to claim 1, TSH of spring leafs made from steels per claim 1 is combined with thermochemical treatment (TCT)-carburization or high temperature carbonitriding (CN) after the initial or repeated heating from a lower optimal temperature that provides for ##10-14 austenitic grain.

9. An automotive leaf spring according to claim 1, the working surfaces of each constant and variable cross section profile leaf with thicknesses bigger than 5 mm, after TCT and TSH, have a carburized martensite structure with carbon content not exceeding 0.8%, but not less than 0.15% higher than in the initial core with 45 . . . 62 HRC hardness and depth that exceeds the initial decarburized layer produced during rolling, less than 0.22 of the leaf thickness; wherein the microstructure and total hardening depth after TCT and TSH are in accordance with claims 2-5; in the core—in accordance with claims 2-5.

10. An automotive leaf spring according to claim 1, with a distinction that the working surfaces of each constant and variable cross section profile leaf with thicknesses bigger than 5 mm, after TCT and TSH, have a carburized hardened martensite structure with carbon content not exceeding 0.8%, but not less than 0.15% of its content in the initial core with 45 . . . 62 HRC hardness and depth that is less than 0.22 of the thickness of the leaf produced after shot blasting of the surface; the core microsection is in accordance with claims 2-5.

11. An automotive leaf spring according to claim 1, spring leafs with the carbon content of higher than 0.6% in the steel or in the surface layer are, after hardening, subjected to treatment with cold at temperatures not higher than minus 60° C.
